(19) United States
(12) Patent Application Publication
(10) Pub. No.: US 2002/0018585 A1
(43) Pub. Date: Feb. 14, 2002

(54) System and method for cardless secure credit transaction processing

(76) Inventor: Young Wan Kim, Seoul (KR)

Correspondence Address: CHRISTIE, PARKER & HALE, LLP, 350 WEST COLORADO BOULEVARD, SUITE 500, PASADENA, CA, 91105, US

(21) Appl. No.: 09/909,406

(22) Filed: Jul. 19, 2001

Related U.S. Application Data
(60) Provisional application No. 60/219,209, filed on Jul. 19, 2000.

(51) Int. Cl. G06K 9/00

(52) U.S. Cl. 382/125

(57) ABSTRACT

In one embodiment, the system and device of the present invention extracts unique numerical information from a fingerprint. A fingerprint is first scanned and the scanned image is enhanced. The blurred area of the image is restored and the enhanced image is binarized. The binarized image is then thinned. A core point in the image is detected and minutiae within a given radius from the core point are detected. A number is then extracted from the image by computing relation of minutiae to the core point.

In one embodiment, the present invention provides a computer data encryption/decryption device and program that uses a fingerprint minutiae generated password to encrypt/decrypt credit card information before sending the information over a computer network. The system uses the finger print along with a public key infrastructure (PKI) and some image processing to ensure the security of the user's accounts.

### CROSS-REFERENCE TO RELATED APPLICATION(S)

This patent application claims the benefit of the filing date of United States Provisional Patent Applications Ser. No. 60/219,209, filed Jul. 19, 2000 and entitled “SYSTEM AND METHOD FOR CARDLESS SECURE CREDIT TRANSACTION PROCESSING”; the entire contents of which are hereby expressly incorporated by reference.

### FIELD OF THE INVENTION

The present invention relates to data security and data authentication. Specifically, the present invention is directed to a system and method for extracting unique numerical information from a fingerprint.

### BACKGROUND OF THE INVENTION

In the last few years, there has been an exponential interest and growth in business transactions over the Internet. The Internet has recently been popularized by the rapid success of the Web. The Web links together a variety of computers from around the world and various topics in a non-sequential network of associations which permit a user to browse from one topic to another, regardless of the format and order of topics. Users access and browse the Web using a web browser that generally resides and is executed on the user's computer.

Billions of dollars are spent every year shopping on the Internet. One can already buy almost anything on the Internet—whether it be a book or a new car. However, there is a major problem with online shopping due to the fact that the Internet is inherently an insecure network. As data packets travel across the Internet, anyone along the way could conceivably intercept and examine those packets. Because of that, there are potential risks to doing business online. Specially if a buyer makes a payment over the Internet with a credit card.

A number of ways to make payments across the Internet have recently sprung up to solve this problem. Most of these methods use procedures and protocols designed to make financial transactions on the Internet as confidential as possible, using encryption technology to make sure that no one can steal a credit card number. Typically, schemes for secure transactions take two approaches. One approach encrypts personal financial information, such as a credit card number, so that it can be transferred across the Internet in a manner that would not let unauthorized people read the data. The second method creates a system of cyber-dollars, electronic credits that only authorized merchants can redeem for real money.

The Secure Electronic Transaction protocol (SET) has been endorsed by VISA, MasterCard, American Express, Microsoft, and Netscape, among other companies. SET describes a way that people can shop online and have the purchases charged to their credit cards.

In addition to secured credit card transactions, a number of companies are working on electronic, or “cyber-dollar” scenarios that will enable consumers to purchase goods and services anonymously. That is, the consumer uses the digital equivalent of paper currency to make purchases and need not provide personal information such as, credit card or bank information to do so. Using this method of electronic payment, consumers buy electronic “coins” or “tokens” and use these specially marked and encrypted coins to make purchases.

Both credit card systems and electronic cash systems have their disadvantages. For example, most of the secure e-commerce web sites provide a secured socket layer (SSL) encryption method to protect customers' information when transmitted over the Internet. This method tends to protect the data being transmitted over the Internet by encrypting the data before it is transmitted. However, even if it is assumed that a hacker will not be able to break in this system, a remaining major concern is that merchants have buyers credit card information. Customers use their credit cards to shop online from many online store. There are many ways these online stores can take advantage of this information. Furthermore, in case of a credit card fraud, it would be very difficult to find out who used the credit card without the permission of the card holder. Sometime, it is the employees or people who have access to the data in any of the e-commerce companies that a buyer had shopped.

Another concern is having too many credit cards. On average, a card holder has three credit cards. To solve the problem of having too many cards, many companies are trying to find the best way to store all of credit card and other information into a smart card, however, if the smart card is stolen or lost, then someone may gain access to all the credit card and personal information. However, smart cards for online shopping transmit credit card information online, even though, the information is encrypted with a smart card code. Similarly, merchants can still have access to the credit card information. Therefore, smart cards like regular credit cards, still provide the credit card information to merchants and transmit the information over the Internet, which may be intercepted by unauthorized hackers. Additionally, even with a smart card, the card holder needs to have the card or memorize the card information such as, the card number, expiration date, etc. Additionally, smart cards are prone to being lost.

### SUMMARY OF THE INVENTION

The system and method of the present invention overcomes the disadvantages of the existing systems by using fingerprint as a password or a key to secure data resulting in the following advantages over the existing systems: convenience, flexibility, portability, different fingerprint sequences can be used for different purposes, can fit in any crypto algorithm as long as, the algorithm requires a password, and hardware independent.

In one embodiment, the invention extracts unique numerical information from a fingerprint called Fingerprint To Number (FTN) gateway. A fingerprint is first scanned and the scanned image is enhanced. The blurred area of the image is restored and the enhanced image is binarized. The binarized image is then thinned. A core point in the image is detected and minutiae within a given radius from the core point are detected. A number is then extracted from the image by computing relation of minutiae to the core point.

In one embodiment, the present invention provides a computer data encryption/decryption device and program that uses a fingerprint minutiae generated password to encrypt/decrypt credit card information before sending the information over a computer network. The system uses the finger print along with a public key infrastructure (PKI) and some image processing to ensure the security of the user's accounts.

In one aspect, the invention describes a method for obtaining a numerical value from a fingerprint comprising the steps of: enhancing a scanned image of the fingerprint; restoring the enhanced image; binarizing the restored image; thinning the binarized image; detecting a core point in the thinned image; detecting minutiae within a predetermined radius from the core point; and extracting the numerical value by computing relations of the minutiae to the core point.

In another aspect, the invention discloses a fingerprint scanning device comprising: means for scanning a fingerprint for obtaining a fingerprint image; means for enhancing the fingerprint image; means for restoring the fingerprint image; means for binarizing the fingerprint image; means for thinning the fingerprint image; means for detecting a core point in the fingerprint image; means for detecting minutiae within a predetermined radius from the core point; and means for extracting the numerical value by computing relations of the minutiae to the core point.

General purpose computers, special purpose computers, networked computing systems, and/or special hardwares, such as a Digital Signal Processor (DSP) chips are capable of performing the steps of the present invention.

### BRIEF DESCRIPTION OF THE DRAWINGS

The objects, advantages and features of this invention will become more apparent from a consideration of the following detailed description and the drawings, in which:

FIG. 1 is an exemplary block diagram for the client/server architecture, according to one embodiment of the present invention;

FIG. 2 is an exemplary process flow diagram showing the use of a fingerprint to encrypt data, according to one embodiment of the present invention;

FIG. 3 is an exemplary registration process, according to one embodiment of the present invention;

FIG. 4 is an exemplary purchasing process, according to one embodiment of the present invention;

FIG. 5 is an exemplary process flow chart for merchant site information handling, according to one embodiment of the present invention;

FIG. 6 is a simplified system for a cardless secure transaction processing, according to one embodiment of the present invention;

FIG. 7 is an exemplary process flow chart for registration process, according to one embodiment of the present invention;

FIG. 8 is an exemplary flow chart for purchasing process, according to one embodiment of the present invention;

FIG. 9 is an exemplary process flow chart for merchant site information handling, according to one embodiment of the present invention;

FIG. 10 is an exemplary diagram depicting examples of how a numerical value is extracted from a processed image, according to another embodiment of the present invention;

FIG. 11 is an exemplary process flow for extracting a unique numerical information from a fingerprint, according to one embodiment of the present invention;

FIGS. 12A-B are exemplary diagrams depicting a binarized imaged obtained from a gray scale image, according to one embodiment of the present invention;

FIG. 13 is an exemplary diagram depicting a core point, according to one embodiment of the present invention;

FIGS. 14A-B are exemplary diagrams depicting a transformed image, according to one embodiment of the present invention;

FIGS. 15A-15D are exemplary diagrams depicting examples of how a color change is counted, according to one embodiment of the present invention; and

FIGS. 16A-16B are exemplary diagrams depicting examples of how a numerical value is extracted from a processed image, according to one embodiment of the present invention.

### DETAILED DESCRIPTION OF THE INVENTION

In one embodiment, the present invention is a system and method for extracting unique numerical information from a fingerprint. The system then uses the extracted number as a seed to generate a variable length of numerical information as a “password” to use with any encryption formula that requires a key or password to encrypt data. The length of the generated numerical information “password” depends on the resolution of the fingerprint scanning unit and the method of numerical information extraction algorithms. In one embodiment, the numerical information can be a combination of any number of fingerprints. Furthermore, the information can be more then one persons's fingerprint combination.

In one embodiment, the present invention uses a fingerprint-capturing device (scanner) to capture fingerprint image and then transforms it to a digital image. After image enhancements and pattern recognition processes, digital image is then transformed into numerical information and applied into an encryption formula (algorithms). In another embodiment, the present invention provides fingerprint scanning and transforms the scanned image into a “minutiae” as digital data. This digital data is then used as a “secret key” in a cryptographic formula for data encryption and user authentication. The system creates a binary file based on this minutiae key and securely stores the binary file.

In one embodiment, the invention describes a cardless credit/debit card transaction processing system. The system can store multiple card information in a highly secured manner, thus eliminating any need to carry any credit card or debit card. Biometric methods are utilized to identify and authorized transactions in an encrypted and secure environment. Encryption/decryption methods may be applied using multiple fingerprint sequences rather than only one fingerprint. For example, a login fingerprint can be a left thumb fingerprint while the fingerprint authorization sequence may use the left second finger and the right thumb.

In one embodiment, a computer controlled system notifies users about their purchase detail information through a channel of delivery. These channels of delivery include: voice call, pager alert, e-mail, SMS (short messaging system), instant messaging system, facsimile, and the like.

In one embodiment, the present invention employs a public kiosk to provide access to Internet through an ISP. FIG. 1 shows a block diagram of a typical Internet client/server environment used by the users in one embodiment of the present invention. PCs (or public kiosks) 220a-220n used by the users are connected to the Internet 221 through the communication links 233a-233n. Optionally, a local network 234 may serve as the connection between some of the PCs 220a-220n, such as the PC 220a and the Internet 221. Servers 222a-222m are also connected to the Internet 221 through respective communication links. Servers 222a-222m include information and databases accessible by PCs 220a-220n. In one embodiment of the present invention, a computer program for extracting a unique numerical value from a fingerprint and providing cardless secure credit transactions resides on at least one of the servers 222a-222m and is accessible by the potential buyers and credit card holders using one or more of the PCs 220a-220n.

In one embodiment of the present invention, each of the PCs (kiosks) 220a-22 n typically includes a central processing unit (CPU) 223 for processing and managing data; and a keyboard 224 and a mouse 225 for inputting data. A main memory 227 such as a Random Access Memory (RAM), a video memory 228 for storing image data, and a mass storage device 231 such as a hard disk for storing data and programs are also included in a typical PC. Video data from the video memory 228 is displayed on the display 230 by the video amplifier 229 under the control of the CPU 223. A communication device 232, such as a modem, provides access to the Internet 221. Optionally, one or more of PCs 220a-22 n may be connected to a local network 234. An Input/Output (I/O) device 226 reads data from various data sources and outputs data to various data destinations.

Servers (hosts) 222a-22m are also computers and typically have architecture similar to the architecture of PCs 220a-220n. Generally, servers differ from the PCs in that servers can handle multiple telecommunications connections at one time. Usually, servers have more storage and memory capabilities, and higher speed processors. Some servers (hosts) may actually be several computers linked together, with each handling incoming web page requests. In one embodiment, each server 222a-22m has a storage medium 236a-236m, such as a hard disk, a CD drive, and the like for loading computer software. When a software such as the software responsible for executing the processes in FIGS. 2-8 is loaded on the server 222a, an off-the-shelf web management software or load balancing software may distribute the different modules of the software to different servers 222a-222m. Therefore, in one embodiment, the computer program responsible for executing the present invention resides on one or more servers.

An exemplary web site location 235 is shown on server 222a in FIG. 1. In one embodiment of the present invention, a secure file including a finger print may be securely stored by a user by accessing web site 235 as described below in more detail. The web site 235 has a unique address that is used by the users to access server 222a (in this example) and the web site location on the server 222a. The computer software for executing the steps of the present invention may also partially reside on the web site 235.

An enormous amount of information is sent and stored over the Internet every day-everything from personal e-mail to corporate data to credit card information and other highly sensitive material. Because the information is sent in packets along public routers, the possibility exists that someone could intercept the information, or retrieve the information from the storage facilities. As a way to ensure that the sensitive material can't be looked at, the present invention uses sophisticated cryptographic system and method so that only the sender can retrieve the data from the remote storage facilities.

The Internet is a notoriously insecure network. Anything that is sent across it or stored in storage connected to it can be tampered with. This is of particular concern when confidential information, such as personal data and credit card numbers, is transmitted and stored across the Internet. Another related concern is that it can be difficult to know that the person sending the information across the Internet, such as credit card information, is really who he says he is. There are ways for people to forge identities and steal credit card numbers, and financial institutions and other businesses require ways to know that the person sending information really is who he says he is.

In one embodiment, the present invention uses finger print based encryption that uses finger prints as encryption keys. The system then uses the encryption key to transmit data over the Internet. In public key cryptography, two keys are involved: a public key and a private key. Every person has both a public key and a private key. The public key is stored in a secure PKIserver and is not publicly available. This embodiment is a closed system where only the PKIserver can use the public key to identify the data is coming from the “real” source, not a fake source. However, the private key is kept secret on the person's computer. The public key can encrypt messages, but only the private key can decrypt messages that the public key has encrypted. The invention uses a binary file generated from scanning the user's finger print as the private key to encrypt the credit card information and decrypt the data.

In one embodiment, the invention uses digital certificates that use encryption to authenticate the person sending information, a credit card number, a message, or other data over the Internet. The system uses human fingerprint to digitally sign and encrypt the message sent to payment gateway. As a result, users can shop anywhere in the world, and there is no need to restrict a user to his own computer. When someone with a digital certificate goes to a site or sends e-mail, that certificate is presented to the site or attached to the e-mail, and it verifies that the user is who he claims to be. The information has been encrypted in a way that makes it unique to the user. In one embodiment, the system of the present invention utilizes the finger print of the user (explained in more detail below) to generate a unique digital signature to be used by that user to verify the authenticity of the user.

A typical financial transaction on the Internet works as follow. Suppose a buyer browses through an electronic catalog on a Web site and he decides to buy a book. To use the Secure Electronic Transaction protocol (SET) to pay for the book, the buyer needs a credit card from a participating bank and a unique “electronic signature” for his computer. This information will verify who the user is, i.e., what computer the signature is coming from. However, because the certificate is installed on a user computer, any person who has access to the user computer can use the user's account to purchase goods without user's authorization.

The system of the present invention alleviates this problem by utilizing the account owner's fingerprint for authenticating and authorizing the account owner. Furthermore the present invention eliminates fix location problem of today's verification systems, by no longer requiring installation of certificates on any machine identification purposes. A potential consumer can freely shop anywhere around the world using any computer or POS system. Moreover, unlike SET, that can only be used on a card issuing bank that is a SET member, the system of the present invention is bank independent, meaning that any bank's credit card can use the system. This system does not need any bank to join or accept any specific rules or application.

For the system of the present invention, the merchant does not need to know where the order comes from nor the identity of the buyer is needed. Since the user uses fingerprint to verify and encrypt information, the system can easily authenticate the buyer. This design also protects unnecessary personal data leaks, specially when stored in a third party system, for example, the merchant's system.

The present invention uses “closed” PKI system for merchant identification purpose. The merchant sends verification to the buyer that the order has been made. The merchant's software creates an authorization request for payment and includes with the merchant's digital signature the transaction identifier and the PI received from the buyer. The software encrypts all of it and sends the encrypted request to the payment gateway. The payment gateway decrypts the messages and uses the merchant's digital signature to verify that the message is from the merchant. By examining the PI, it verifies that they have come from the buyer. The payment gateway then uses a bank card payment system to send an authorization request to the bank that issued the buyer his bank card, asking if the purchase can be made.

When the bank responds that the payment can be made, the payment gateway creates, digitally signs, and encrypts an authorization (approval) message. This message is then sent to the merchant. The merchant's software decrypts the message and uses the digital signature to verify that it came from the payment gateway. Assured of payment, the merchant now ships the book to the buyer. Some time after the transaction has been completed, the merchant requests payment from the bank. The merchant's software creates a capture request, which includes the amount of the transaction, the transaction identifier, a digital signature, and other information about the transaction. The information is encrypted and sent to the payment gateway.

The payment gateway decrypts the capture request and uses the digital signature to verify it is from the merchant. It sends a request for payment to the bank, using the bank card payment system. It receives a message authorizing payment, encrypts the message, and then sends the authorization to the merchant. The merchant software decrypts the authorization and verifies that it is from the payment gateway. The software then stores the authorization that will be used to reconcile the credit card payment routinely when it is received from the bank.

There are many existing encryption algorithms such as, RSA, DSA, etc. All of these encryption algorithms involve altering the original data into different one by means of performing certain calculation on the original data. Some systems use hardware address or ID as a key, however, it requires the user to perform the encryption/decryption on the same machine.

A Public Key Infrastructure (PKI) algorithm uses a certification authority (CA) and issues a private key that resides in the user's computer and a public key that is obtainable by the receiver of the message. If the user wants to encrypt a message and send it to others, the user has to perform the encryption in his own computer. While the receiver of the message can get the public key to decrypt the message anywhere around the world.

FIG. 2 is an exemplary process flow diagram showing the use of a fingerprint to encrypt data according to one embodiment of the present invention. In block 201, a fingerprint scanner scans human fingerprint “live scan” into an image format. Live scan is a fingerprint scanning process that detects human fingerprints by temperature, contact pressure, etc. Then, some image processing is performed to enhance the finger print image in block 202. Image processing includes noise reduction, image enhancement, thinning, minutia detection, etc. The digital image of the fingerprint is then converted into a binary number, as shown in block 203. The system then uses this number as “password” for an encryption algorithm to encrypt the target data, as shown in block 204. In block 205, data such as credit card information is encrypted using the fingerprint-based password.

In one embodiment, password length can be increased to improve security by using multiple fingerprints and with different sequence. For example, numbering fingers in 0-9, starting from left to right. Then, using the two thumbs will be “56” and using both small fingers will be “09”. Furthermore, a larger number of fingers can be used in different sequence and frequency to obtain an even more secure system.

In one embodiment, the credit card information is stored in a data center, so that the user can access this data at anytime anywhere using Internet. The data is stored in an encrypted form which means user has complete privacy for her data. A compatible fingerprint and a computer program record new member's fingerprint minutiae for system login and identification purposes. A software program including a specific private key is used to obtain the member's fingerprint minutiae key, encrypt it with the private key and send it to the data center to complete the registration process. The private key is preferably hard-coded in the program. In one embodiment, an all-in-one device, combines scanner and encryption module in a fingerprint reader unit, with hardware encoded key for encrypted transmission.

New member's fingerprint minutiae is sent to the data center in encrypted form with the private key that is sent with the membership package. In the data center, a public key that is stored with user ID in a secured database is used to decrypt the encrypted message. This message is a payload data including the encrypted fingerprint minutiae key from the user. The decrypted message (result) is the original minutiae from the user. This fingerprint is for future login verification purpose. This encrypted message is encrypted with specific private key (the one that was sent to the new member). If member's encrypted fingerprint minutiae key cannot be decrypted in the data center, new member needs to retry the process in order to complete the registration process.

Once registration is completed, the member only needs to type in a user ID and position his/her finger in the fingerprint reader. User ID is encrypted with member fingerprint minutiae and is sent to data center for login request. Then, the data center decrypts the user ID with the presorted fingerprint minutiae key. A portable fingerprint reader unit with Internet connection capability may be provided in the post offices (or any other convenience place) for the new member to complete the registration process.

In one embodiment, the system of the present invention (M1 system) provides services to both existing and new credit/debit card members. Customers register their banking information (like credit card information, debit card information, etc.) with system's Secured Relay Data Center. All customer information are stored in an encrypted form by means of their own fingerprints as a “key”. When using this embodiment to purchase goods online, customers simply input their userID and their Login fingerprint scan. The Secured Relay Data Center then displays to the customer a pop up screen that includes data such as, “name of card issuing bank” for the customer to choose from. After deciding which card to charged to, the customer then use the system to scan the fingerprint authorization sequence (may have more than one fingerprints). Banking information is then decrypted from the Secured Relay Data Center and is sent to the Merchant Bank for credit processing via line with security capabilities, such as ISO8583.

FIG. 3 illustrates an exemplary registration process according to one embodiment of the present invention. As shown in block 302, a customer may apply for a system account through mail, online registration, FAX, etc. Once an account is established, in block 304, the system checks to see whether the customer is the owner of the applied banking information, i.e. credit card, debit card owner etc. If the customer chooses to purchase a fingerprint scanning device, a fingerprint scanning unit along with the proper software is shipped to customer, as illustrated in block 306. In block 308, using the installed fingerprint scanning unit, the system sends the customer login fingerprint scan to the secured data center 312. If a fingerprint scanning device is not available to the customer, the customer may visit a service station (e.g., a post office, bank, etc.) to scan his finger print.

The first time fingerprint registration is encrypted by a “hard coded” private key in the fingerprint scanner (block 310), then decrypted later with the public key in the data center 312. In block 318, after successful login to the system, the customer is required to send in banking information and the fingerprint authorization sequence scan to a secured database. The fingerprint authorization may include more then one fingerprint with different sequences. Banking information is then encrypted using customer's fingerprint authorization as a “Key” and stored in the secured relay data center 316. As a result, only the customer can decrypt the banking information using his/her fingerprint.

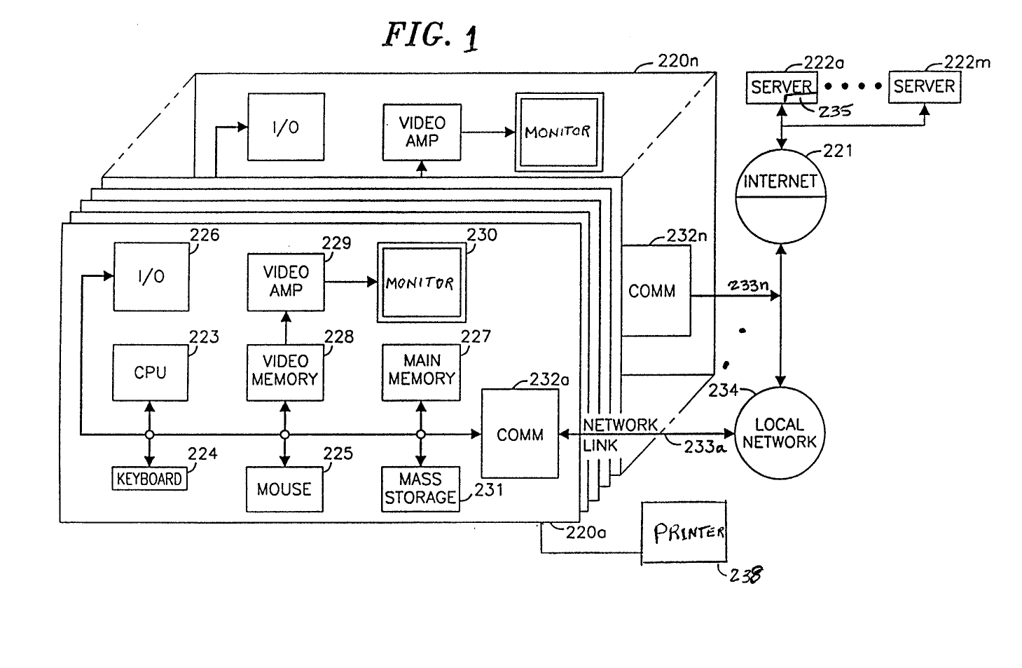

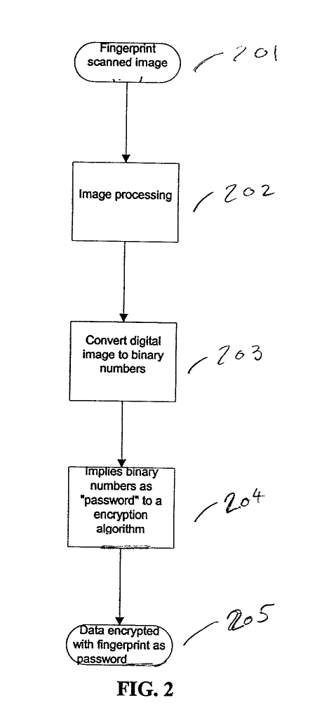

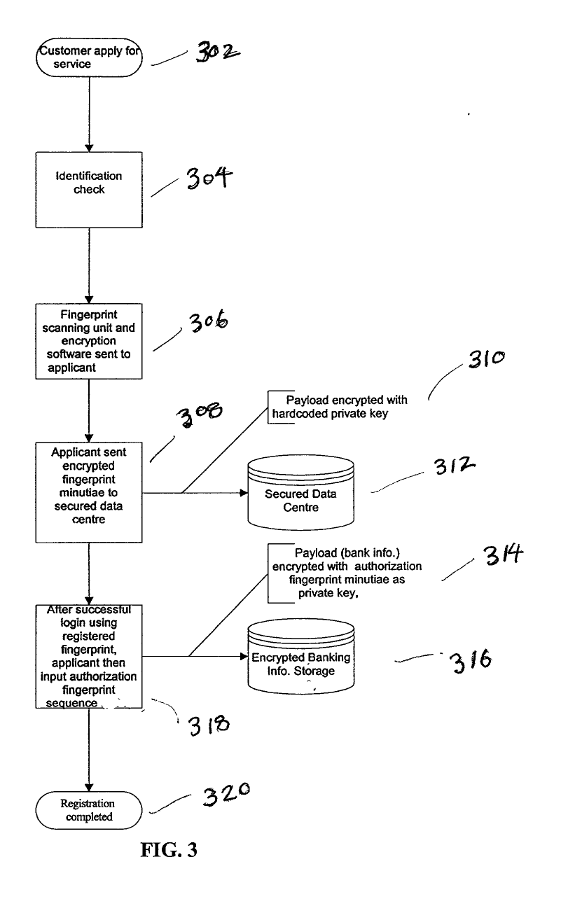

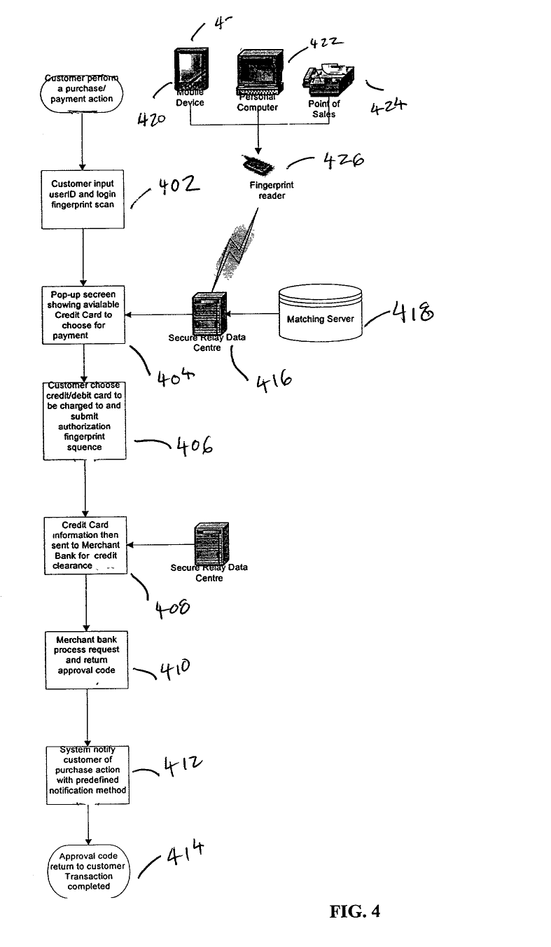

FIG. 4 shows an exemplary purchasing process according to one embodiment of the present invention. The customer may purchase goods and services on any online store. Such store should have M1 Payment method (the above described embodiment) enabled. The customer can access M1 payment method form any computing device that has Internet access and has a compatible fingerprint-scanning device 426. (e.g.,. mobile device 420, PC at home 422, public kiosk 424, etc.). In block 402, the customer enters his userID and the login fingerprint scan. The userID is encrypted with the login fingerprint and sent to the secured relay data center 416 for login purpose. The system then queries the database 418 for a list of all registered banking information by the customer. In block 404, a pop-up screen displays to the customer information including registered credit/debit card (bank name only, no number) information on file.

The customer can choose which card to use and then submits fingerprint authorization sequence scan, as shown in block 406. The encrypted card information is then retrieved from the secured relay data center database and is decrypted with customer's fingerprint authorization. Card information and purchase details are then encrypted and sent to merchant bank for credit processing, as shown in block 408. The credit information is processed and approval information is returned to the merchant (the online shop in this case), as shown in block 410. The system then passes the approval information to the Notification server and sends a purchase notification to the customer according to his/her preferences in block 412. The notification can be a voice call, pager alert, Fax etc. The matching server stores the login fingerprint and the customer registered banking information.

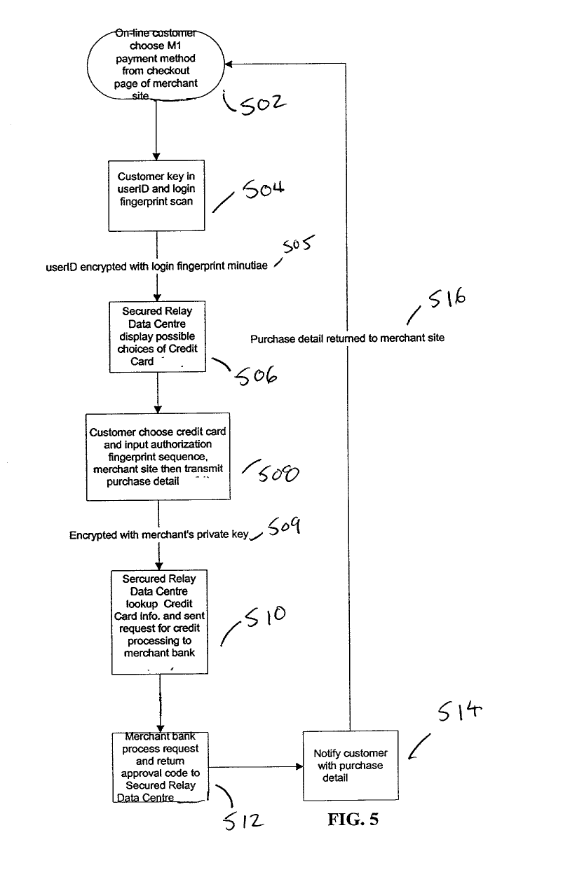

FIG. 5 depicts an exemplary process flow chart for merchant site information handling according to one embodiment of the present invention. Once in the merchant web site, the customer proceeds to check out the site and chooses an M1 payment method in block 502. The customer then enters userlD and logs in the fingerprint scan that is sent to the data center in encrypted form in block 504. In block 505, the userlD is encrypted with login fingerprint and is transmitted to the data center via Internet with SSL. The server in the data center returns possible choices of credit/debit card issuing bank name in a pop-up screen, as depicted in block 506. The customer then chooses credit/debit card name and enters fingerprint authorization sequence in block 508. In block 509, the payload is encrypted with merchant side private key and is delivered to the data center.

The server in the data center then looks up credit card information and decrypts the information with customer's fingerprint authorization. The system then encrypts card information and payment details and send them to merchant bank, as shown in block 510. Merchant bank sends the credit process information to data center in block 512. The system then forwards approval information to merchant site via Internet with SSL. A notification with purchase details is then sent to the customer via customer pre-selected channel in block 514. The purchase detail is then returned to the merchant site, as shown in block 516.

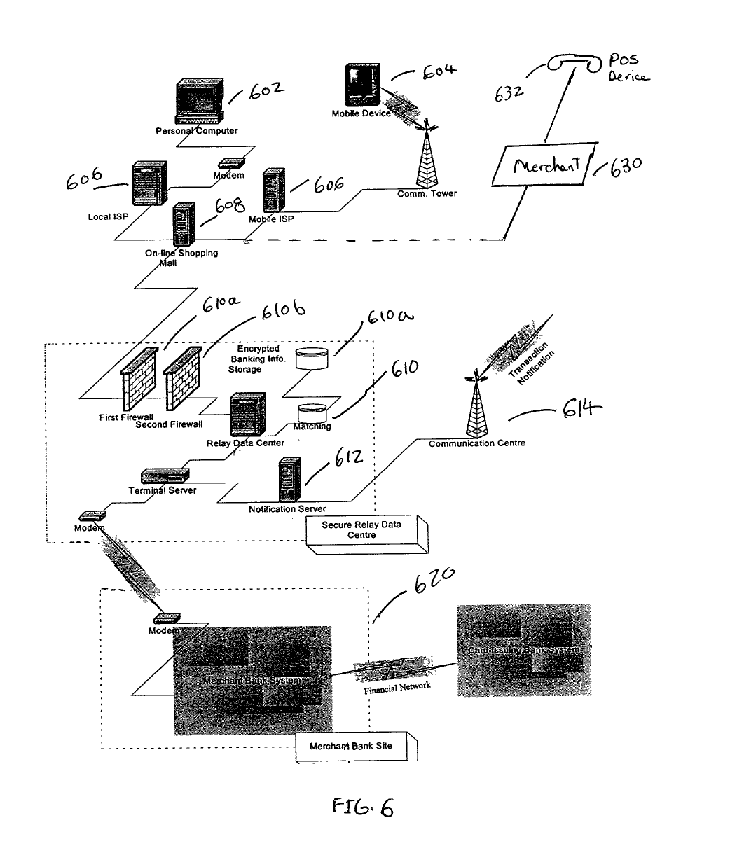

FIG. 6 shows a simplified system according to one embodiment of the present invention. A customer visits an online shopping site 608 with M1 payment system enabled using a PC 602 or a mobile device 604 and an ISP 606. The customer can access an online shopping site via any computer device that includes a fingerprint reader. A double firewall infrastructure includes two firewalls 610a and 610b, preferably from two different firewall vendors. This is mainly to prevent hacker attacks on brand name firewall. Login fingerprint information is stored in a database 610a in a matching server 610. The matching server 610 matches a user to a respective financial institution. A pop-up screen displays all registered credit/debit card names. Encrypted banking information storage 620 stores encrypted card information. Only the customer's own fingerprint (fingerprint authorization) can decrypt this information. This action only occurs when a purchase action is initiated by the customer. A notification of purchase detail is then sent out to the customer via a notification server 612 and a notification communication center 614.

In one embodiment, the present invention provides service to both new and existing credit/debit card customers (M2 system). With this system, purchasing good and services at any point of sale (POS), including online shopping no longer require a physical card and pin. In this embodiment, the M2 system uses a fingerprint reader to collect customer's login fingerprint (similar to M1 system) and the card number is stored in a matching server located within individual's card issuing bank's site. This embodiment allows existing banking systems to remain intact, while incorporating the new biometric identification and encryption method to provide highly secured electronic transaction environment.

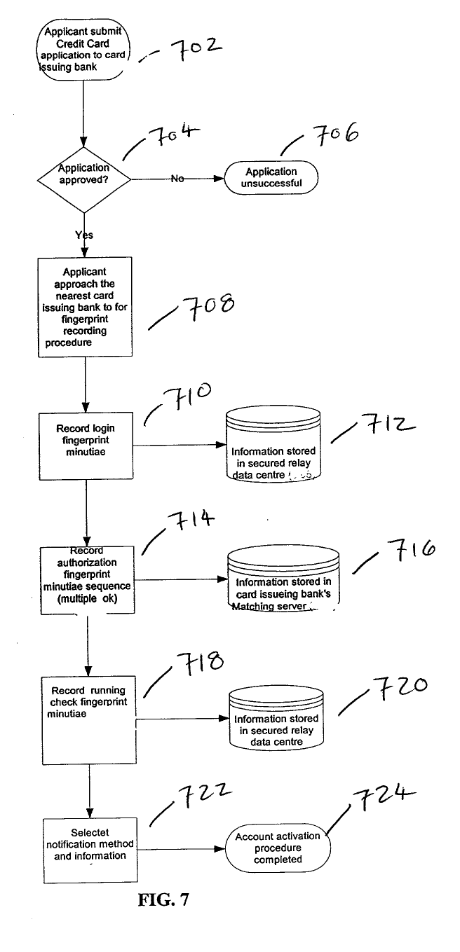

FIG. 7 depicts an exemplary flow chart for registration process, according to the above embodiment of the present invention. A customer submits credit/debit card in block 702. Existing cardholders may also use this service at their card issuing bank. This is due to credit card information being stored in a card issuing bank for the above embodiment. The application goes through normal credit card approval procedures according to individual bank, as shown i block 704. When application is approved, the customer uses a fingerprint reader to record login fingerprint scan and obtains a userlD, as shown in block 708. In block 710, the login fingerprint is encrypted with the service center's private key and is sent to the data center for login and multi-card lookup purposes. The data center stores the userID and login fingerprint minutiae for multi-card lookup service in block 712. In block 714, the customer then enters fingerprint authorization sequence (may be multiple fingers) into the Matching Server located within the card issuing bank's data center. The Matching Server looks up credit card information when a purchasing action is initiated by the customer. In this embodiment, customer's credit card information is stored in their card issuing bank and the M2 system does not know the customer's card information.

The Matching Server located at the card issuing bank's data center stores the userlD and card information, as shown in block 716. This information may include card holder name, card number, expiration date, billing address, etc. When a purchase action occurs, the Matching Server uses fingerprint authorization sequence to decrypt the card information stored in the Matching Server. The system then sends that credit card information and purchase detail to the card issuing bank for credit processing. An optional transaction security check feature is provided to the customer. This feature requires the customer to record one more fingerprint scan (block 718) and stores it in a data Center, as shown in block 720. When the system detects an extensive usage of an account, the customer (Account holder) may be required to present the extra fingerprint scan as an extra security feature.

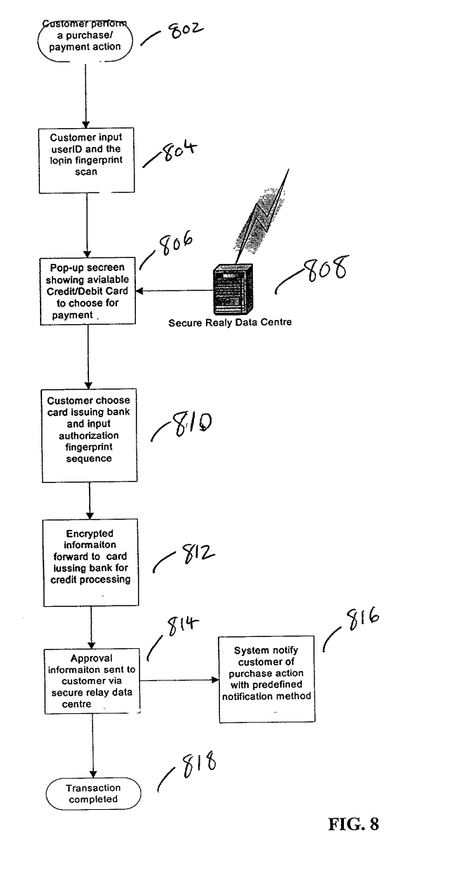

FIG. 8 depicts an exemplary flow chart for purchasing process according to the above described embodiment of the present invention. In block 802, the customer performs a purchasing action (POS or online store) with M2 Payment method selected. The customer then enters his userlD and the login fingerprint scan in block 802. The data center looks for userID and the POS system displays to the customer a list of customer registered credit/debit card issuing bank name only, as shown in block 806. In block 810, the customer chooses which credit/debit card to use and submits fingerprint authorization sequence (i.e., one or more fingerprint). Purchase details and fingerprint authorization are encrypted with the data center's private key and then sent to customer's card issuing bank, as illustrated in block 812. The Matching Server decrypts the encrypted information with a public key obtained from the data center and looks up encrypted credit card information from the matching database according to the userlD. The matching server then decrypts the credit card information and sends it to the card issuing bank with purchase details for credit processing. Approval information is then returned to the merchant and the customer via the data center, as shown in block 814. Notification server then sends purchase notification to customer via a pre-selected communication channel similar to M1 system, as depicted in block 816.

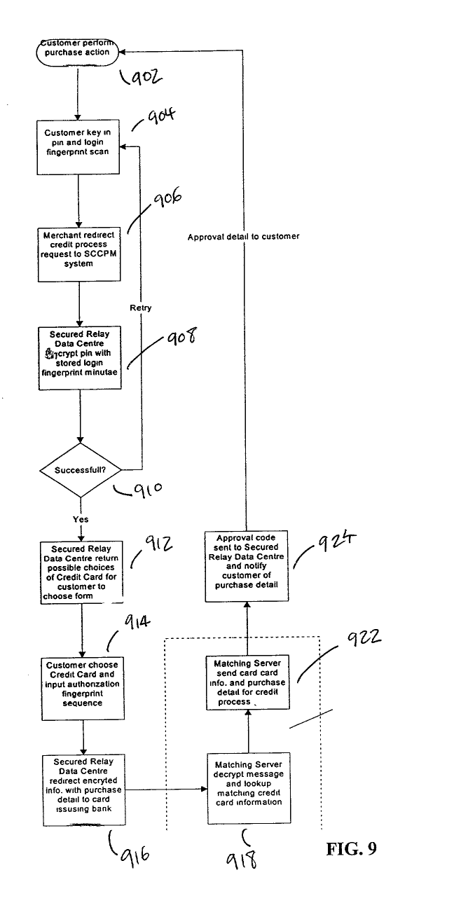

FIG. 9 illustrates an exemplary process flow chart for merchant site information handling according to the above described embodiment of the present invention. After the customer enters in a userlD and login fingerprint scan (block 904), the merchant system redirects purchase detail, userlD and login fingerprint encrypted with merchant's private key to the data center via an Internet connection, as shown in block 906. This merchant system and the POS device are depicted in FIG. 6 as Merchant 630 and POS device 632. Also the merchant Bank site 620 of FIG. 6 is replaced with the Card Issuing bank site in this embodiment. In block 908, the payload is encrypted in the data center with merchant's public key. The system then looks up credit/debit card listing (financial institute name only) from Matching Storage within the data center. The data center then returns card listing to the merchant's terminal, as shown in block 912.

The customer chooses a financial institute to be used from the card listing and then inputs fingerprint authorization sequence in block 914. The data center then encrypts the purchase detail with the private key. This information is then redirected to customer's choice of card issuing bank's Matching Server. The fingerprint authorization sequence for credit card information resides inside card issuing banks' Matching Server. This means the data center does not store fingerprint authorization sequence, that sequence only resides in the Matching server location typically, within the card issuing banks' site.

The Matching Server typically located within the card-issuing bank then decrypts the payload with the data center's public key, as shown in block 918. The system then matches the userlD and fingerprint sequence to the received purchase detail and card information and sends it to card issuing bank for credit processing in block 922. In block 924, an approval code is then sent to the data center to notify the customer via pre-selected notification methods. The approval information in then sent to the merchant. In this embodiment (M2 system), all credit/debit card information retrieval and decryption are performed within the card issuing bank's data center and there is no need to modify the existing financial systems.

A fingerprint is typically formed from composite curve segments. The top part is called “ridges” and the lower portion is called “valleys.” The ridges and valleys alternate, flowing in a local constant direction. The “minutiae” are the small features formed by crossing and ending of ridges in the fingerprint ridges flow pattern. In other words, minutia refers to the ridge ending and bifurcation of a fingerprint pattern. Other important fingerprint features include: core and delta, which can be served as a “landmark” for orientation and act as a “singularity Point”.

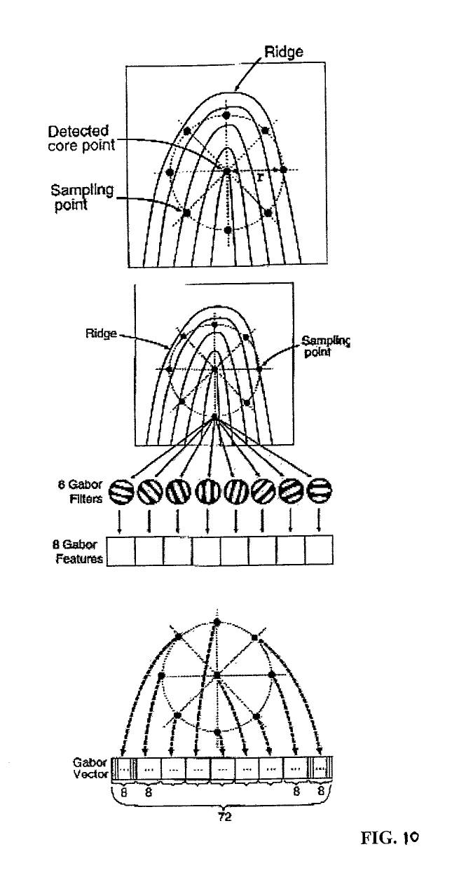

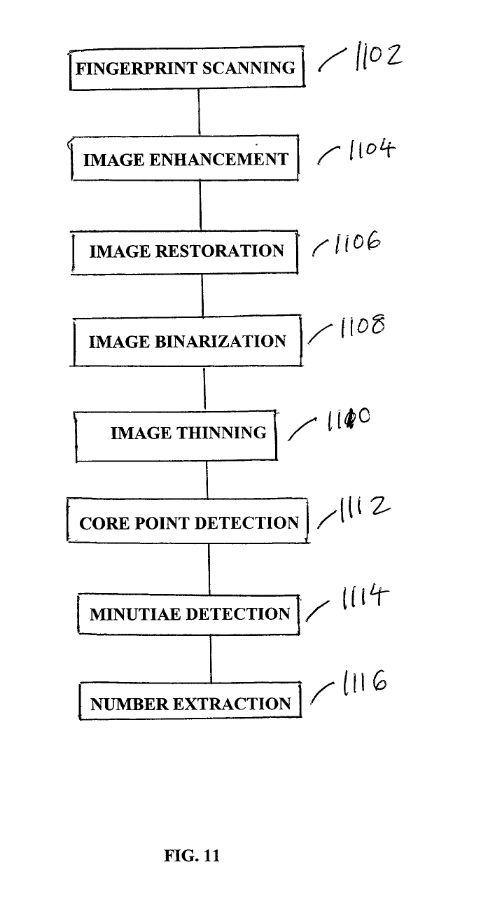

FIG. 11 is an exemplary process flow for extracting a unique numerical information from a fingerprint, according to one embodiment of the present invention. In block 1102, gray scale fingerprint image are scanned from a fingerprint scanner. Typically a 500 dpi (dot per inch) resolution is currently used, i.e., every inch of scanned image contains 500 pixels of information. After a gray scale image is acquired from the fingerprint scanner, the system performs an image enhancement step, as shown in block 1104. This process overcomes some undesired image degradation effects like wrinkles, scars, dirt, finger dryness, etc. In one embodiment, this step includes enhancing contrast and edge of each ridge. Then, an enhanced image is acquired using histogram equalization process. The histogram equalization process is well know to people skilled in the art of image processing. The noise in the image is then filtered out. The ridge is then distinguished from the blank area (valley) by sharpening the edges of the ridge. Finally, the rough edges of each ridge are smoothen out.

In block 1106, the blurred image acquired during scanning is restored and the noise is filtered out again. The geometric distortion is corrected and, inverse filtering and least means square filtering, such as the well-known Wiener filtering are then applied.

Before thinning the image lines, gray-scale image should be transformed into binary (black and white) image. As shown in block 1108, the gray scale image is converted to a black-and-white image through a binarization process. Gray-scale image typically has an intensity level between 0 to 255. Intensity level 0 means black and intensity level 255 means white. (for gray-scale, intensity level can be regarded as a degree of brightness) As a result of converting gray scale image into binary image, the image lines are changed to black and between the lines are filled with white. If scanned image has lines with similar intensity level, the image can be easily transformed by setting a threshold of a certain intensity level. In this case if the line's intensity level is lower than that of threshold, it is changed into black and the blank area are filled with white.

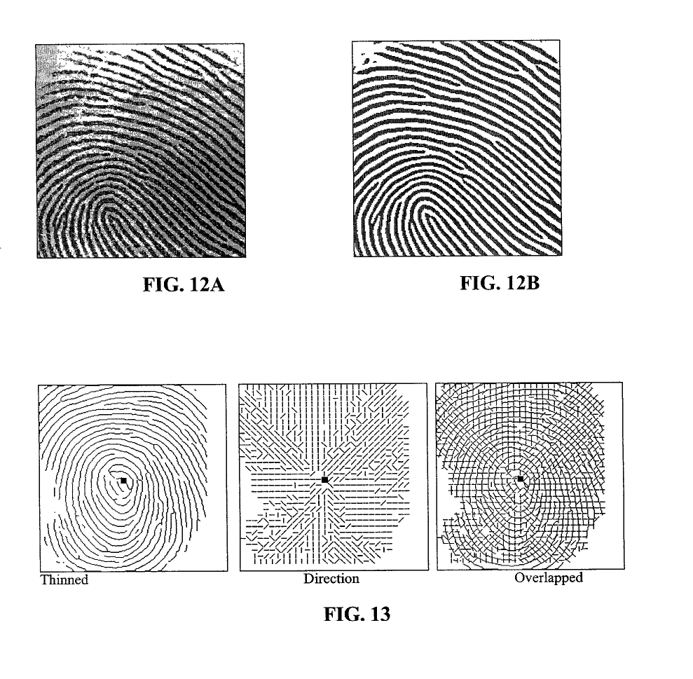

In most cases, however, it is very difficult to obtain a clear image that includes lines with similar intensity levels. To overcome this problem, the method and system of the present invention performs the following steps. The image is partitioned and divided into several small areas. Then, an average intensity level of lines within an area is calculated. This average intensity is set as a threshold and the gray-scale image of the area is transformed to binary image. This process is then repeated for each partitioned area until binarization is completed. FIG. 12B depicts an exemplary binarized imaged obtained from a gray scale image of FIG. 12A.

A binary to skeleton processing, called “thinning” may also be performed on the image, as illustrated in block 1110. A skeleton image is produced by eroding the objects within a binary image until they are one pixel wide. In other words, the width of the black lines are thinned to 1 pixel. The advantage derived from using a skeleton image is that extraction of ridge features becomes a relatively straightforward procedure based on tracing line segments. In one embodiment, the well known method described in T. Y. Zhang and C. Y. Seun, A Fast Parallel Algorithm for Thinning Digital Patterns, journal of Communications of ACM, 1984, 9, 236-239, the entire contents of which are hereby incorporated by reference; is used to perform the thinning.

After a skeleton image is generated from the gray scale fingerprint image, the core point of the fingerprint is determined in block 1112. A core point is defined as center of a fingerprint, where the direction lines meet each other, or on ridge line, as shown in FIG. 13. To detect the core point of an image, a core area needs to be detected first. To detect a core area, the image is first segmented, i.e., the thinned image is divided into square areas, for example areas of 8×8 pixels with only one or two black lines.

This process shortens the time required for processing an image. For example, using the above segmentation, it takes 1/64 of the time required for processing a 256×256 pixel image without segmentation to search the same image. After segmenting the image, a Fast Fourier Transform (FFT) process is applied to each square area. The FFT process enables a computer program to recognize a line in a given area as a combination of dots, and also recognize the density of dots along a line. For example, even on the same line, the density of dots may be high on some area and low on other areas. A direction line vertical to the tangent of a given line in each segment is then extracted. This line represents the direction of a line that can be obtained by slicing the line at a given point. That is why FFT process is applied to fingerprint image.

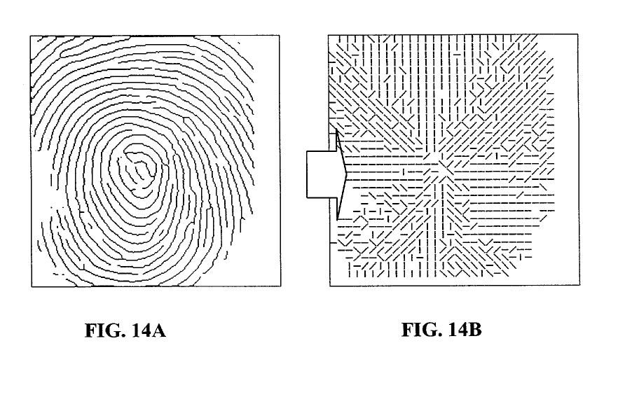

As a result of the above process, the image of the fingerprint is replaced with the combination of straight lines crossing from one side to the opposite side of the square area, as shown in FIGS. 14A-14B. The straight lines are then classified into 4 types; vertical, horizontal, a slope with left end high, and a slope with right end high. Each type of line is numbered from 0 to 3 in order. As a result, the fingerprint image is transformed into a matrix of 32×32 (squares). The matrix is then processed by the column using the following two methods. Note that, a column which includes core area has the largest number of squares which are filed with vertical direction lines.

A. Core area exists on a column which has the most squares with number zero (vertical direction lines), or

B. Core area exists on a square whose upper squares in the same column all have number zero.

As a result of the above methods, several squares may be obtained. Core point exists on the square that meets the condition of definition B.

To detect the core point (pixel) within the detected core square, the detected core square obtained above, together with its neighboring squares are further segmented to smaller squares of 4×4 pixels. The above process for detecting core square is applied to the smaller square(s) to detect a smaller core square. The highest pixel on a smaller core square that is on the ridge line is the core point (pixel).

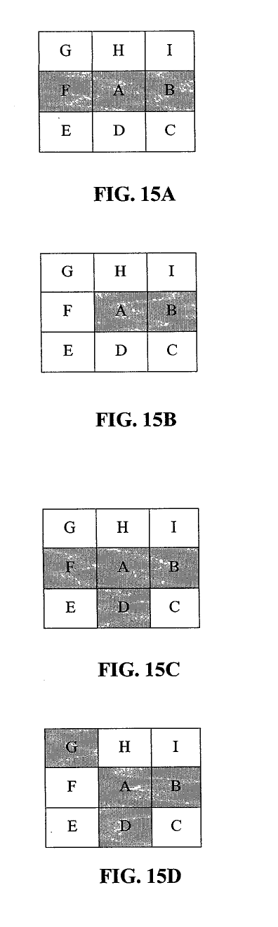

After the core point is detected, the minutiae have to be detected. Although, every fingerprint image has several minutiae, in one embodiment, only the bifurcation minutiae are detected. First, every 3×3 pixel window is processed to detect connectivity of the pixels within each window. The number of times that color changes from block to white is then counted. FIGS. 15A-15D depict examples of how the color change is counted. In FIG. 15A, the color changes from black to white twice, i.e., B to C, and F to G for a line. Thus, the central pixel (A) is tagged with a number 2. In FIG. 15B, the color changes from black to white only once, i.e., B to C, for a termination. Thus, the central pixel is tagged with a number 1. In FIG. 15c, the color changes from black to white three time, i.e., B to c, D to E, and F to G for a bifurcation. Therefore, the central pixel is tagged with a number 3. Finally, in FIG. 15D, the color changes from black to white three times, i.e., B to C, D to E, and G to H for a bifurcation. As a result, the central pixel (A) is tagged with a number 3. Thus, the pixels flagged with a number 3, are bifurcation minutiae where a ridge splits. Next, pixels with bifurcation are sorted by the order of their distance from the core point.

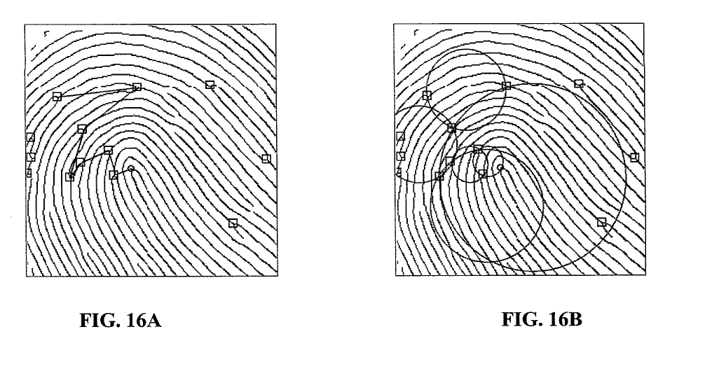

The final process is extracting a unique number from the image, as shown in block 1116 of FIG. 11. Some exemplary methods to accomplish this task are described below. The first method, numbers the pixels with bifurcation by the order of their distance from the core point, b1, b2, b3, b4, b5, b6, . . . , etc. The distance between the core point and b1=d1, and distance between b1 and b2=d2 are calculated. Next, a circle with core, b1 and b2 on its circumference is drawn, and its radius r1 is calculated, as shown in FIGS. 16A and 16B. The first part of the numerical information, d1, d2, r1 is acquired in order. Then, the distance between b2 and b3=d3 is calculated, a circle with b1, b2 and b3 on its circumference is drawn, and the radius r2 is calculated. The second part of the numerical information, d3, r2 is then obtained in order. Then, the distance between b3 and b4=d4 is calculated, a circle with b2, b3, and b4 on its circumference is drawn, and the radius r3 is calculated. The third part of the numerical information, d4, r3 is then obtained in order. The above procedure is repeated with all bifurcation pixels within a certain distance from the core point. As a result, the number obtained from the fingerprint is in the form of d1d2r1d3r2d4r3d5r4 . . . .

A second exemplary method for extracting a unique number from the image is shown in FIG. 10. This method re-orients the image to a direction, for example, parallel to y-axis. Then, from the detected core point, on a circle with a radius r, sampling points are obtained. A sampling point refers to a vector of ridge flow pattern (flow direction), as shown in FIG. 10. Eight sampling points information are then combined into a numerical value, as shown in FIG. 10.

According to a third exemplary method, from the detected core point, a circle with a radius r is reached and minutiae in different segments within that radius are detected. Then, the numbers of ridges between the core point and the reference minutiae are counted, and added up to obtain the numerical value.

The above method may be carried out using a general purpose computer, a special purpose computer, a networked computing system, or a special hardware, such as a Digital Signal Processor (DSP) chip. As described above, any or all of the hardware for performing the above steps may be embodied in a single fingerprint scanner device. After a unique numerical value is determined from the fingerprint, the numerical value may used as a password, or a key that is used by an encryption module for data encryption/decryption, or other data security purposes.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention, as defined by the appended claims.

What is claimed is:

1. A method for obtaining a numerical value from a fingerprint comprising the steps of:
enhancing a scanned image of the fingerprint;
restoring the enhanced image;
binarizing the restored image;
thinning the binarized image;
detecting a core point in the thinned image;
detecting minutiae within a predetermined radius from the core point; and
extracting the numerical value by computing relations of the minutiae to the core point.

2. The method of claim 1, wherein the step of enhancing comprises the steps of:
enhancing the contrast of each ridge in the image;
filtering noise;
partition a ridge area from a blank area by sharpening edges of each ridge; and
smoothening rough edges of each ridge.

3. The method of claim 1, wherein the step of restoring comprises the steps of:
correcting geometric distortion of the image; and
applying inverse filtering to the image.

4. The method of claim 1, wherein the step of restoring comprises the steps of:
correcting geometric distortion of the image; and
applying least square filtering to the image.

5. The method of claim 1, wherein the step of binarizing comprises the step of converting the image to a black and white image.

6. The method of claim 1, wherein the step of binarizing comprises the steps of:
setting a predetermined threshold level;
changing a point in a line to a black color if the point intensity is lower than the threshold value.

7. The method of claim 1, wherein the step of binarizing comprises the steps of:
partitioning the image into a plurality of smaller areas;
computing average intensity level of line within each smaller area;
setting the intensity level of each smaller area as a threshold level for the respective area; and
transforming gray-scale image of each smaller area to a binary image.

8. The method of claim 1, wherein the step of thinning comprises the step of reducing the width of each black line in the image to one pixel.

9. The method of claim 1, wherein the step of detecting a core point comprises the steps of:
determining a core area; and
detecting a core point in the determined core area.

10. The method of claim 9, wherein the step of determining a core area comprises the steps of:
segmenting the image into smaller areas;
applying a FFT process to each segmented smaller area;
extracting a direction line for each line in the each smaller area to obtain an image of a respective directional straight line for each smaller area;
classifying each directional line to a vertical, a horizontal, a left slope, and a right slope type;
assigning a respective flag to each of the classified directional lines to obtain a matrix with columns and rows, wherein each column of the matrix includes a plurality of smaller areas;
determining a core area in a column with most number of vertical directional lines; and
determining a core area in a segmented smaller area whose each of its upper smaller areas in the respective column include a vertical directional lines.

11. The method of claim 10, wherein the step of determining a core point in the determined core area comprises the steps of:
segmenting the determined core area into smaller squares;
applying a FFT process to each segmented smaller square;
extracting a direction line for each line in the each smaller square to obtain an image of a directional straight line for each smaller square;
classifying each directional line to a vertical, a horizontal, a left slope, and a right slope type;
assigning a respective flag to each of the classified directional lines to obtain a matrix with columns and rows, wherein each column of the matrix includes a plurality of squares;
determining a core square in a column with most number of vertical directional lines;
determining a core square in a segmented smaller square whose each of its upper smaller squares in the respective column include a vertical directional lines; and
determining a highest pixel on a ridge line in the core square.

12. The method of claim 1, wherein the step of detecting minutiae comprises the step of detecting bifurcation minutiae.

13. The method of claim 12, wherein the step of detecting minutiae comprises the steps of:
dividing the image to a plurality of 3×3 pixel squares; for each of the plurality of squares:
counting the number of color changes from black to white, starting at the center pixel;
assigning the number to the central pixel; and
determining pixels with an assigned number of 3 as bifurcation minutiae.

14. The method of claim 1, wherein the step of extracting the numerical value comprises the steps of:
ordering the detected minutiae by their respective distance from the detected core point as b₁, b₂, b₃, . . . bₙ, wherein b is a detected minutia and n is the total number of detected minutiae;
computing a distance between the core point and b₁, as d₁;
computing a distance between b₁, and b₂ as d₂;
computing a radius r₁ of a circle including the core point, b₁, and b₂ on its circumference;
for each of the remaining minutiae b₁, from b₃ to bₙ:
computing a distance between b₁₋₁ and b₁ as dᵢ;
computing a radius r₁₋₁ of a circle including b₁₋₂, bᵢ₋₁, and bᵢ on its circumference; and
assembling the numerical value by combining d₁d₂r₁d₃r₂d₄r₃ . . . dₙ rₙ₋₁.

15. The method of claim 1, further comprising the step of utilizing the extracted numerical value as a key for data encryption.

16. The method of claim 1, further comprising the step of utilizing the extracted numerical value for data authentication for online shopping.

17. The method of claim 1, further comprising the step of utilizing the extracted numerical value for a cardless secure transaction.

18. The method of claim 1, wherein the transaction is performed over the Internet.

19. A fingerprint scanning device comprising:
means for scanning a fingerprint for obtaining a fingerprint image;
means for enhancing the fingerprint image;
means for restoring the fingerprint image;
means for binarizing the fingerprint image;
means for thinning the fingerprint image;
means for detecting a core point in the fingerprint image;
means for detecting minutiae within a predetermined radius from the core point; and
means for extracting the numerical value by computing relations of the minutiae to the core point.

20. The device of claim 19, wherein the means for enhancing comprises:
means for enhancing the contrast of each ridge in the image;
means for filtering noise;
means for partition a ridge area from a blank area by sharpening edges of each ridge; and
means for smoothening rough edges of each ridge.

21. The device of claim 19, wherein the means for restoring comprises:
means for correcting geometric distortion of the image; and
means for applying inverse filtering to the image.

22. The device of claim 19, wherein the means for restoring comprises:
means for correcting geometric distortion of the image; and
means for applying least square filtering to the image.

23. The device of claim 19, wherein the means for binarizing comprises means for converting the image to a black and white image.

24. The device of claim 19, wherein the means for binarizing comprises:
means for setting a predetermined threshold level;
means for changing a point in a line to a black color if the point intensity is lower than the threshold value.

25. The device of claim 19, wherein the means for binarizing comprises:
means for partitioning the image into a plurality of smaller areas;
means for computing average intensity level of line within each smaller area;
means for setting the intensity level of each smaller area as a threshold level for the respective area; and
means for transforming gray-scale image of each smaller area to a binary image.

26. The device of claim 19, wherein the means for thinning comprises means for reducing the width of each black line in the image to one pixel.

27. The device of claim 19, wherein the means for detecting a core point comprises:
means for determining a core area; and
means for detecting a core point in the determined core area.

28. The device of claim 27, wherein the means for determining a core area comprises:
means for segmenting the image into smaller areas;
means for applying a FFT process to each segmented smaller area;
means for extracting a direction line for each line in the each smaller area to obtain an image of a respective directional straight line for each smaller area;
means for classifying each directional line to a vertical, a horizontal, a left slope, and a right slope type;
means for assigning a respective flag to each of the classified directional lines to obtain a matrix with columns and rows, wherein each column of the matrix includes a plurality of smaller areas;
means for determining a core area in a column with most number of vertical directional lines; and
means for determining a core area in a segmented smaller area whose each of its upper smaller areas in the respective column include a vertical directional lines.

29. The device of claim 28, wherein the means for determining a core point in the determined core area comprises:
means for segmenting the determined core area into smaller squares;
means for applying a FFT process to each segmented smaller square;
means for extracting a direction line for each line in the each smaller square to obtain an image of a directional straight line for each smaller square;
means for classifying each directional line to a vertical, a horizontal, a left slope, and a right slope type;
means for assigning a respective flag to each of the classified directional lines to obtain a matrix with columns and rows, wherein each column of the matrix includes a plurality of smaller squares;
means for determining a core square in a column with most number of vertical directional lines;
means for determining a core square in a segmented smaller area whose each of its upper smaller areas in the respective column include a vertical directional lines; and
means for determining a highest pixel on a ridge line in the core square.

30. The device of claim 19, wherein the means for detecting minutiae comprises means for detecting bifurcation minutiae.

31. The device of claim 30, wherein the means for detecting minutiae comprises:
means for dividing the image to a plurality of 3×3 pixel squares;
for each of the plurality of squares:
means for counting the number of color changes from black to white, starting at the center pixel;
means for assigning the number to the central pixel; and
means for determining pixels with an assigned number of 3 as bifurcation minutiae.

32. The device of claim 19, wherein the means for extracting the numerical value comprises:
means for ordering the detected minutiae by their respective distance from the detected core point as b₁, b₂, b₃, . . . bₙ, wherein b is a detected minutia and n is the total number of detected minutiae;
means for computing a distance between the core point and b₁ as d₁;
means for computing a distance between b₁ and b₂ as d₂;
means for computing a radius r₁ of a circle including the core point, b₁, and b₂ on its circumference;
for each of the remaining minutiae b₁, from b₃ to bₙ:
means for computing a distance between bᵢ₋₁ and b₁ as d₁;
means for computing a radius r₁₋₁ of a circle including b₁₋₂, b₁₋₁, and b₁ on its circumference; and
means for assembling the numerical value by combining d₁d₂r₁d₃r₂d₄r₃. . . . dₙ rₙ₋₁.

33. The device of claim 19, further comprising means for utilizing the extracted numerical value as a key for data encryption.

34. The device of claim 19, further comprising means for utilizing the extracted numerical value for data authentication for online shopping.

35. The device of claim 19, further comprising means for utilizing the extracted numerical value for a cardless secure transaction.

36. The device of claim 19, wherein the transaction is performed over the Internet.

37. A computer readable medium having stored thereon a set of instructions including instruction for obtaining a numerical value from a fingerprint, the instructions, when executed by a computer cause the computer to perform the steps of:
enhancing a scanned image of the fingerprint;
restoring the fingerprint image;
binarizing the fingerprint image;
thinning the fingerprint image;
detecting a core point in the fingerprint image;
detecting minutiae within a predetermined radius from the core point; and
extracting the numerical value by computing relations of the minutiae to the core point.
